(19) United States
(12) Patent Application Publication
(10) Pub. No.: US 2013/0103601 A1
(43) Pub. Date: Apr. 25, 2013

(54) SYSTEM AND METHOD FOR PERFORMING A SECURE ONLINE SEARCH

(71) Applicant: Branch Recruiting, Hawthorn Woods, IL (US)

(72) Inventor: Thomas J. Daley, Hawthorn Woods, IL (US)

(73) Assignee: BRANCH RECRUITING, Hawthorn Woods, IL (US)

(21) Appl. No.: 13/656,381

(22) Filed: Oct. 19, 2012

Related U.S. Application Data
(60) Provisional application No. 61/549,006, filed on Oct. 19, 2011.

(51) Int. Cl. G06Q 10/06

(52) U.S. Cl. 705/321

(57) ABSTRACT

One embodiment of the invention relates to a computer implemented method and system for recruiting individuals using an online search community. The method includes creating at least one microsite associated with a firm using provided online tools; creating at least one profile for a position associated with the at least one microsite; creating an anonymous ID for at least one recruit; blocking access to at least one micro site based on information provided by at least one of the firm and the at least one recruit; enabling the at least one recruit to access the at least one profile position; enabling the at least one recruit to communicate with at least one microsite; enabling the at least one recruit to disclose selected identifying information; and enabling the firm to review the at least one recruit's disclosed identifying information.

### CLAIM FOR PRIORIY

This application claims priority from U.S. Provisional Application Ser. No. 61/549,006 filed Oct. 19, 2011 titled “SYSTEM AND METHOD FOR PERFORMING A SECURE ONLINE SEARCH” the complete subject matter of which is incorporated herein by reference in its entirety.

### FIELD OF THE INVENTION

This invention generally relates generally to computing systems and data processing. More specifically, it relates to a computer system and method for acquiring information on prospective recruits and evaluating their candidacy for job openings.

### BACKGROUND OF THE INVENTION

Typically, when an organization needs to hire a new employee, either on a permanent or contract basis, the branch manager in collaboration with the human resources manager drafts a position profile that describes the characteristics expected of the new employee. The position profile typically consists of a detailed description of the role, the skills, knowledge, experience and education required to perform in the role, the team profile, cultural aspects, duration of the position, and commercial aspects associated with the position. This position profile is then published to either an in-house corporate recruitment team and/or a recruitment agency for fulfillment.

Traditionally, the group in charge of fulfilling the job opening advertises the position in print or on electronic media and receives resumes from prospective candidates in response to the advertisement. The resumes are then manually reviewed to assess the qualifications of the candidate, and those candidates whose resumes appear to reflect the qualifications called for in the position profile are then invited for an interview. This process has several drawbacks associated with it, some of which include the limited reach of the job advertisement and manual review of the resumes which is time consuming and error prone. This not only results in qualified candidates either not applying for the position due to the poor reach of the advertisements or not being invited for an interview due to human error in the manual resume review process, but also resumes of less qualified candidates being assessed incorrectly leading to loss of time and possible mis-hire.

Prior art systems such as job boards address these inadequacies to some extent by providing tools for candidates seeking new opportunities to upload their resumes into their system. In addition to advertising the job opening, recruiting agents are offered tools to perform searches for prospective candidates from amongst those candidates that have posted their resumes on the job board's system.

One drawback associated with such job boards is that the candidate's resume is public. That is the candidate's own firm can easily determine the candidate is conducting a job search, thereby placing his current position at risk. It therefore would be advantageous to provide a secure online system and method for recruiting individuals without risking their current positions.

The present invention advances the art. It provides a secure online system and method for recruiting individuals without risking their current positions.

### BRIEF SUMMARY OF THE INVENTION

One embodiment relates to a computer implemented method for recruiting individuals using an online search community. The method includes creating at least one microsite associated with a firm using provided online tools; creating at least one profile for a position associated with the at least one microsite; creating an anonymous ID for at least one recruit; blocking access to at least one microsite based on information provided by the at least one recruit; enabling the at least one recruit to access the at least one profile position; enabling the at least one recruit to communicate with at least one microsite; enabling the at least one recruit to disclose selected identifying information; and enabling the firm to review the at least one recruit's disclosed identifying information.

Yet another embodiment relates to a system for recruiting individuals using an online search community. The system includes a memory for storing instructions and data, the data comprising a set of programs and a dataset having one or more data fields; a processor executing the instructions and processing the data. The instructions include creating at least one microsite associated with a firm using provided online tools; creating at least one profile for a position associated with the at least one microsite; creating an anonymous ID for at least one recruit; blocking access to at least one microsite based on information provided by the at least one recruit; enabling the at least one recruit to access the at least one profile position; enabling the at least one recruit to communicate with at least one microsite; enabling the at least one recruit to disclose selected identifying information; and enabling the firm to review the at least one recruit's disclosed identifying information.

Still another embodiment relates to a non-transitory computer readable storage system including system including a set of computer instructions for aiding recruiting of individuals using an online search community. The set of instructions include a routine for creating at least one microsite associated with a firm using provided online tools; a routine for creating at least one profile for a position associated with the at least one microsite; a routine for creating an anonymous ID for at least one recruit; a routine for blocking access to at least one microsite based on information provided by the at least one recruit; a routine enabling the at least one recruit to access the at least one profile position; a routine enabling the at least one recruit to communicate with at least one microsite; a routine enabling the at least one recruit to disclose selected identifying information; and a routine enabling the firm to review the at least one recruit's disclosed identifying information.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention can be defined by the appended the claims and equivalents thereof.

### BRIEF DESCRIPTION OF THE SEVERAL VIEWS OF THE DRAWINGS

FIG. 1 is a high level view of a system for recruiting individuals using an online search community in accordance with one embodiment of the present invention;

FIG. 2 another high level view of a system for recruiting individuals using an online search community in accordance with one embodiment of the present invention;

FIGS. 3A, 3B and 3C are a high level flow chart illustrating a method of recruiting individuals using the system of FIG. 1 in accordance with one embodiment of the present invention;

FIGS. 4A and 4B are a high level flow chart illustrating a method of recruiting individuals using the system of FIG. 1 in accordance with one embodiment of the present invention;

FIG. 5 is high level flow chart illustrates a method for enabling recruits to access firm profiles using the system of FIG. 1 in accordance with one embodiment of the present invention;

FIG. 6 illustrates a screenshot for recruits using the system and method in accordance with one embodiment of the present invention;

FIG. 7 illustrates a screenshot for recruits using the system and method in accordance with one embodiment of the present invention;

FIG. 8 illustrates a screenshot of a recruit's user profile using the system and method in accordance with one embodiment of the present invention;

FIG. 9 illustrates a screenshot for financial services using the system and method in accordance with one embodiment of the present invention;

FIG. 10 illustrates another screenshot for financial services using the system and method in accordance with one embodiment of the present invention;

FIG. 11 illustrates a screenshot for branch managers using the system and method in accordance with one embodiment of the present invention;

FIG. 12 illustrates another screenshot for branch mangers using the system and method in accordance with one embodiment of the present invention;

Throughout the various figures, like reference numbers refer to like elements.

### DETAILED DESCRIPTION

One or more embodiments relate to a system and method providing an online search community for recruiting in specific industries, the financial service industry for example. Embodiments provide a one-stop portal for recruits to conduct due diligence on companies and postings using standardized search criteria, in addition to providing a one-stop portal for branch managers to conduct all recruiting efforts and increase the efficiency of marketing efforts. Embodiments provide confidential access for recruits to review and interface with branch manager opportunities. Embodiments provide validation services to ensure a recruit in system is accurately reporting their personal profile data and includes access to reports on the entire user community, financial services level and on branch manager recruiting activity.

Embodiments of the system and method provide advantages for financial service firms, alternatively referred to as wirehouse, RIA, regional, independent, insurance based, FI and Hybrid. Embodiments provide front end recruit screening to validate qualification in the due diligence process. Embodiments provide instant promotion and correspondence with the financial service firms (FSFs) selected without searching the FSFs individual internet sites. Embodiments provide direct connection between FSF and their branch manager microsites; streamlining pre-approval of marketing and advertising communications. One or more embodiments provide full range of reporting and advisor tracking on the FSF microsite and their individual branch manager microsites; and provide full visibility over the branch manager recruiting activity.

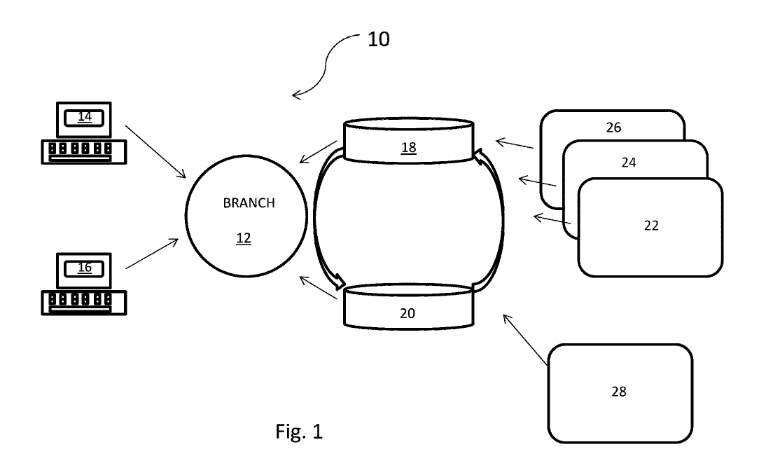

FIG. 1 depicts a high level view of a system, generally designated 10, for recruiting individuals using an online search community in accordance with one embodiment of the present invention. In at least one embodiment, the system 10 (a non-transitory computer readable storage system for example) includes a processor 12 having a memory for storing instructions and data, the data comprising a set of programs and a dataset having one or more data fields; the processor executing the instructions and processing the data. The processor 12 may provide a platform executing at least such microsite creation, profile creation, anonymous tag creation, filtering, accessing, communicating and disclosing.

FIG. 1 illustrates a plurality of remote user interfaces communicating with the processor 12 via any wired or wireless manner as is well known in the art. In at least one embodiment, the user interfaces include computers, desk top computers, main frames, PDS's, smart phones, and the like. FIG. 1 illustrates new advisors from advertising 14 and advisors from financial services firms and branch manager direct marketing 16 communicating with processor 12. FIG. 1 further depicts the system 10 includes at least one or more financial services firm/branch manager microsites 18 and advisor search profiles 20. FIG. 1 further illustrates one or more independent firm 22, regional firm 24 and/or warehouse firms 26 interacting with the system 10. FIG. 1 further illustrates the system 10 includes at least one user profile 28.

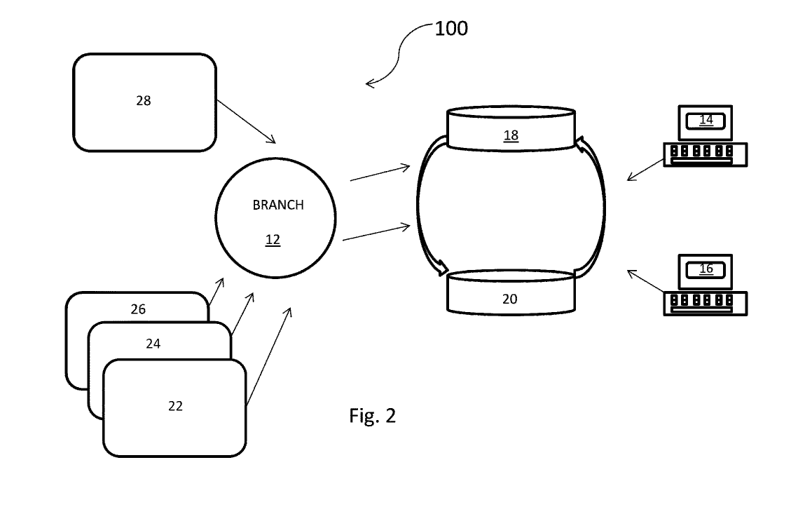

FIG. 2 depicts a high level view of a system, generally designated 100, similar to the system 10 of FIG. 1. FIG. 2 illustrates a plurality of remote user interfaces communicating with the processor 12 via any wired or wireless manner as is well known in the art. The processor 12 may provide a platform executing at least such microsite creation, profile creation, anonymous tag creation, filtering, accessing, communicating and disclosing.

In at least one embodiment, the user interfaces include computers, desk top computers, main frames, PDS's, smart phones, and the like. FIG. 2 illustrates new advisors from advertising 14 and advisors from financial services firms and branch manager direct marketing 16 communicating with processor 12. FIG. 2 further depicts the system 100 includes at least one or more financial services firm/branch manager microsites 18 and advisor search profiles 20. FIG. 2 further illustrates one or more independent firm 22, regional firm 24 and/or warehouse firms 26 interacting with the system 100. FIG. 2 further illustrates the system 100 includes at least one user profile 28.

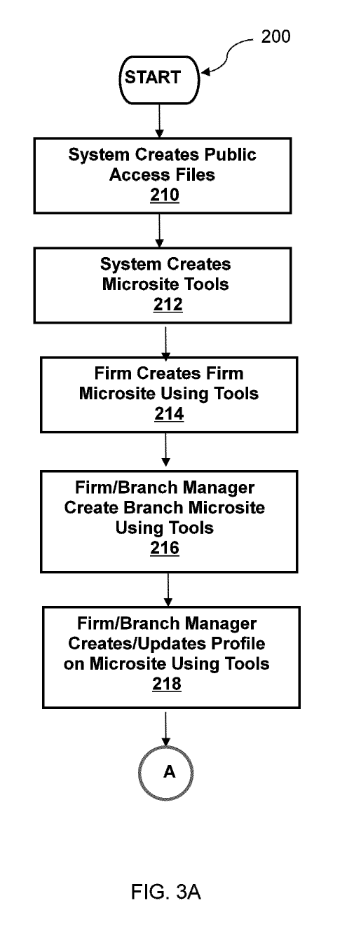

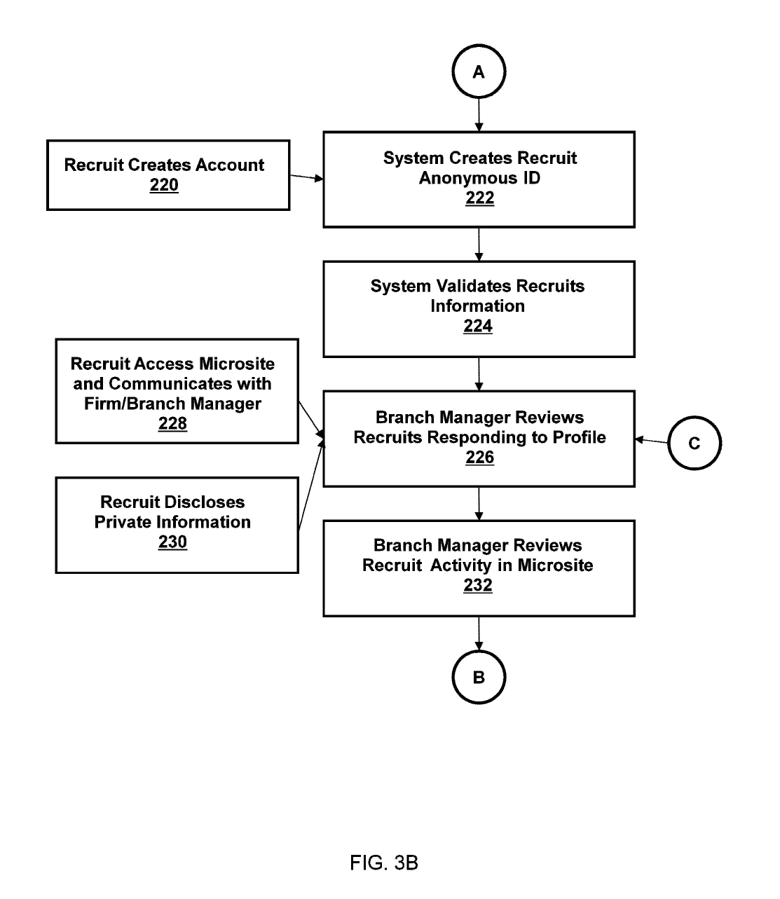

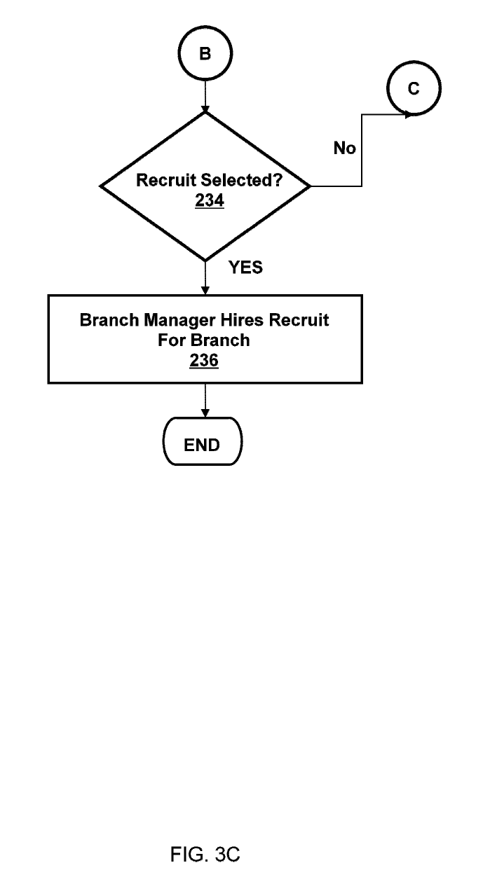

FIGS. 3A, 3B and 3C depict a high level flow diagram illustrating a method, a computer implemented method and generally designated 200, for recruiting individuals using the system of FIGS. 1 and/or 2. FIG. 3A-3C illustrates creating one or more public access files, block 210 and creating and making available one or more microsite tools, block 212.

Method 200 further illustrates the firm creating one or more microsites using the tools, block 214 and a firm/branch manager creating one or more branch microsites using the tools, block 216. In at least one embodiment, the one or more branch microsites are associated with the firm microsite. The method 200 further comprises the firm/branch managers creating and/or updating a profile using the microsite tools, block 218.

One or more embodiments of the present invention relate to one or more microsites that include multimedia, firm profile data, financial criteria and private messaging. The microsite may serve as the landing page for direct marketing initiatives; provide standardized criteria for recruit evaluation; provide dashboard and vault upload capability of approved marketing material for use by branch manages; in addition to providing robust reporting of recruits' profile statistics, search string criteria and branch manager activity. Embodiments provide dashboard and personal vault loaded with recruit marketing capabilities, integrating with direct mail, email, webinar, and text messaging; and pre-defined and ready to launch marketing campaigns, for email and direct mail, alerts and invitation updates and reporting. Embodiments provide search functionality and lead filters to define ideal prospects; feeding into their marketing campaigns for streamlined implementation. Embodiments provide reporting and tracking of recruit activity within their microsite and URL activity.

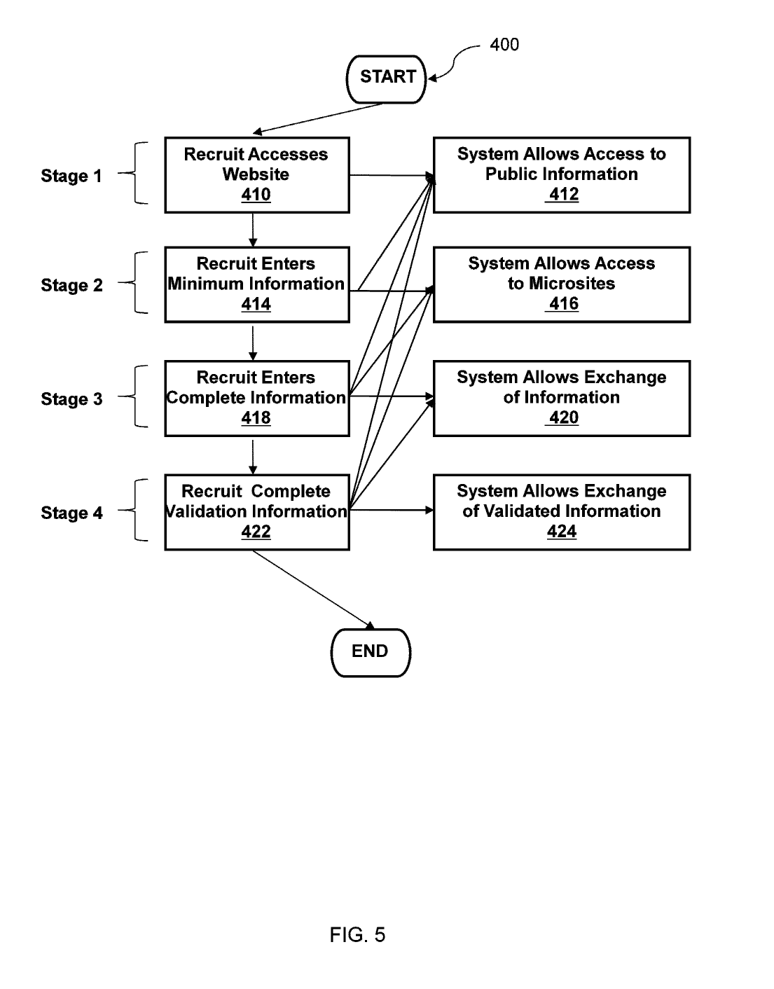

Additionally, the method 200 enables one or more recruits to create an account, block 220 (discussed in greater detail with respect to FIG. 5). The system creates an anonymous ID or tag for the recruit, block 222. In one or more embodiments, the system validates the recruit's information, block 224.

Method 200 further enables the branch manager to review recruits who have responded to the profile, block 226. In at least one embodiment such response may include the system enabling the recruit to communicate with the firm/branch manager, block 228, and/or the recruit disclosing private information, block 230. In at least one embodiment, the method 200 enables the branch manager to review recruit activity on the microsite, block 232. In one or more embodiments, the system may restrict or filter those microsites and/or profiles the recruit may access based on the recruits previous or current employment, and/or the recruit's search criteria.

Finally, the method 200 determines if a recruit is selected, diamond 234. If a recruit is selected, the recruit is hired by the branch, block 236. If the recruit is not selected, the firm/branch manager can update the profile, look at more recruits or terminate the process.

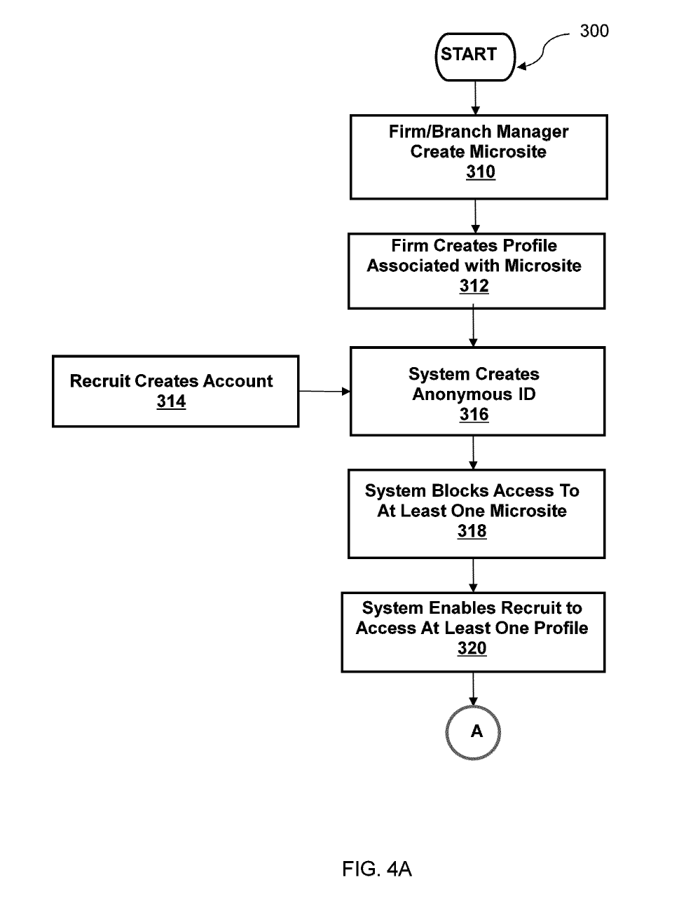

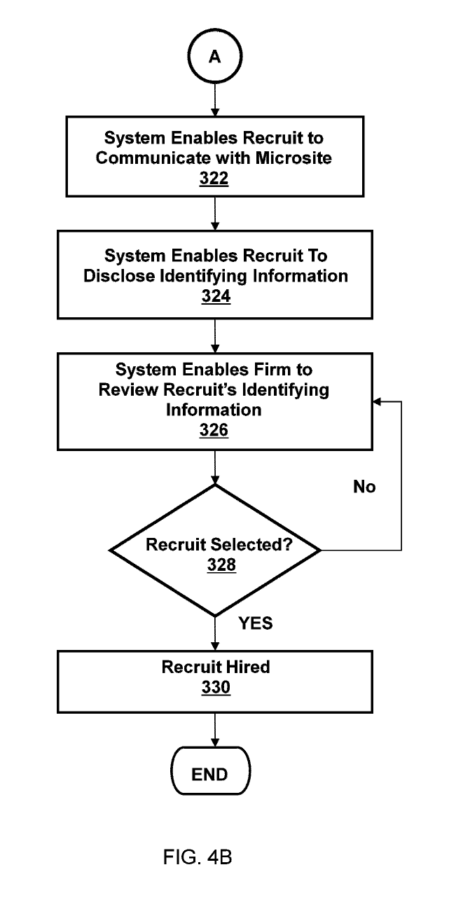

FIGS. 4A and 4B depict another high level flow diagram illustrating a method, a computer implemented method and generally designated 300, for recruiting individuals using the system of FIGS. 1 and/or 2. FIG. 4A-4B illustrates creating at least one microsite associated with a firm using provided online tools, block 310 and creating at least one profile for a position associated with the at least one microsite, block 312.

Additionally, the method 300 enables one or more recruits to create an account, block 314 (discussed in greater detail with respect to FIG. 5). The system creates an anonymous ID or tag for the recruit, block 316. In one or more embodiments, the method 300 includes blocking access to at least one microsite based on information provided by at least one of the firm and the at least one recruit, block 318.

Method 300 further enables the at least one recruit to access the at least one profile position, block 320; enabling the at least one recruit to communicate with at least one microsite, block 322. The system enables the at least one recruit to disclose selected identifying information, block 324; and enables the firm to review the at least one recruit's disclosed identifying information, block 326.

Finally, the method 300 determines if a recruit is selected, diamond 328. If a recruit is selected, the recruit is hired by the branch, block 330. If the recruit is not selected, the firm/branch manager can update the profile, look at more recruits or terminate the process.

In at least one embodiment, method 300 may include profiling the at least one recruit, masking the at least one recruit's identity and/or enabling the at least one recruit to access the at least one profile position without the firm identifying the at least one recruit. The method 300 may further include creating at least one subsidiary microsite associated with the at least one microsite and reviewing the at least one microsite activity. Additionally, method 300 may include validating the at least one recruit's personal information.

FIG. 5 depicts a high level flow chart illustrating a method, generally designated 400, for enabling recruit access using the system of FIGS. 1 and 2. FIG. 5 illustrates there are four stages for access. It should be appreciated that while four stages are illustrated, more or less stages are contemplated. FIG. 5 illustrates that in Stage 1 the recruit may access the website, block 410, and view public information, block 412 (white papers or firm background for example). Method 400 further includes Stage 2, wherein the recruit can sign up, block 414, and using minimum information (user name and password for example). This enables the recruit to access one or more microsites, block 416.

FIG. 5 further illustrates the method 400 includes in Stage 3 the recruit enters additional/complete information, block 418. In at least one embodiment, the system may create an anonymous tag or ID and allow the recruit to exchange information with the firm/branch manager and/or microsite, block 420. Finally, in Stage 4, the recruit enters complete validation information (credit history, W-2 Statements and/or pay stubs for example) block 422. This allows the recruit to exchange information with the firm/branch manager and/or microsite, block 424.

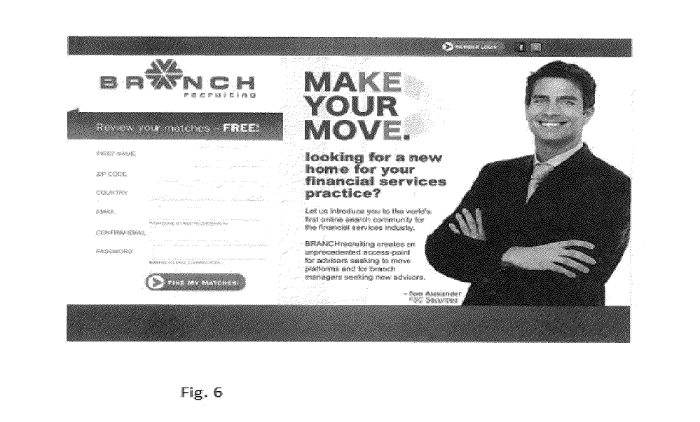

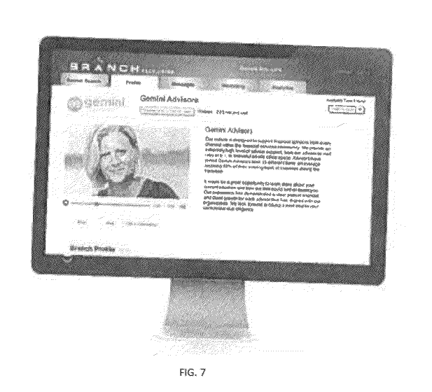

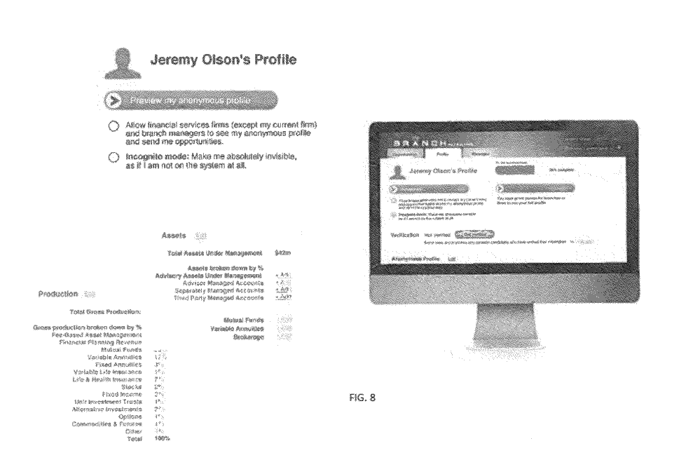

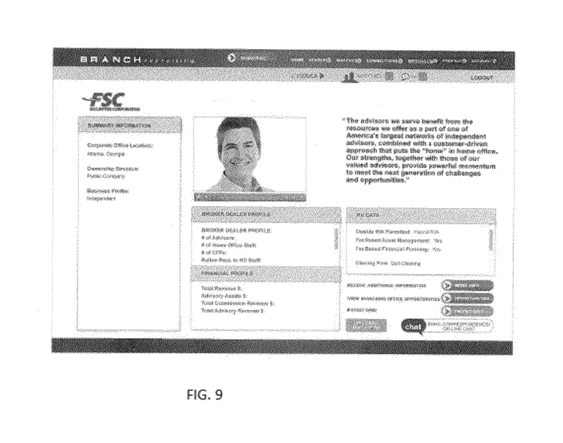

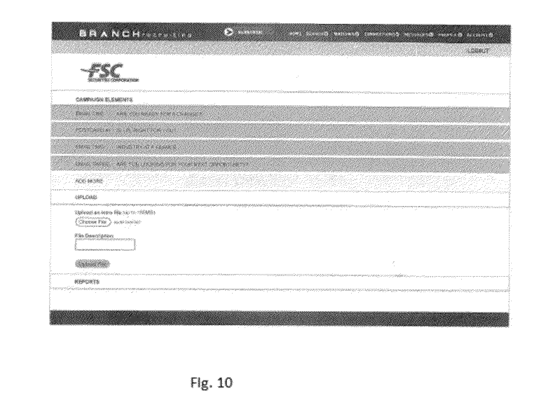

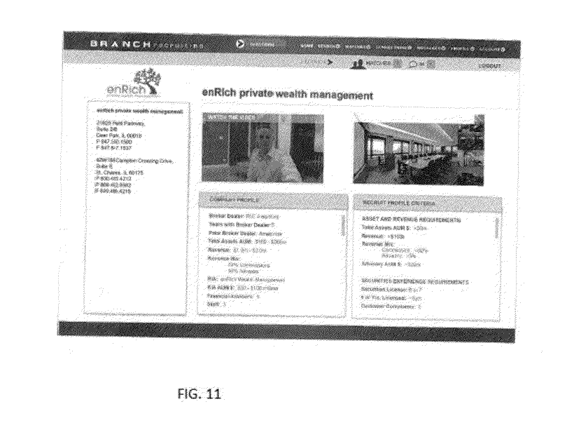

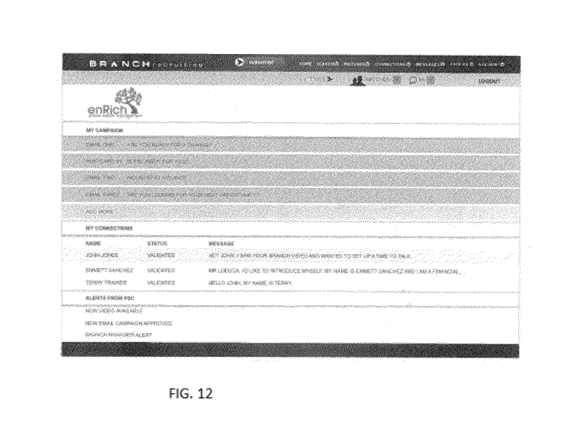

FIGS. 6-12 provide an overview of the system and method including various screenshots in accordance with one or more embodiments illustrated in FIG. 1-5. FIG. 6 illustrates a screenshot for recruits using the system and method in accordance with one embodiment of the present invention; FIG. 7 illustrates screenshot for recruits using the system and method in accordance with one embodiment of the present invention; FIG. 8 illustrates a screenshot of a recruit's user profile using the system and method in accordance with one embodiment of the present invention. FIG. 9 illustrates a screenshot for financial services using the system and method in accordance with one embodiment of the present invention. FIG. 10 illustrates another screenshot for financial services using the system and method in accordance with one embodiment of the present invention. FIG. 11 illustrates a screenshot for branch managers using the system and method in accordance with one embodiment of the present invention; while FIG. 12 illustrates another screenshot for branch mangers using the system and method in accordance with one embodiment of the present invention.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A computer implemented method for recruiting individuals using an online search community comprising:
creating at least one microsite associated with a firm using provided online tools;
creating at least one profile for a position associated with the at least one microsite;
creating an anonymous ID for at least one recruit;
blocking access to at least one microsite based on information provided by at least one of the firm and the at least one recruit;
enabling the at least one recruit to access the at least one profile position;
enabling the at least one recruit to communicate with at least one microsite;
enabling the at least one recruit to disclose selected identifying information; and
enabling the firm to review the at least one recruit's disclosed identifying information.

2. The method of claim 1 further comprising profiling the at least one recruit, masking the at least one recruit's identity.

3. The method of claim 1 further comprising enabling the at least one recruit to access the at least one profile position without the firm identifying the at least one recruit.

4. The method of claim 1 further comprising enabling the firm to identify and hire the at least one recruit.

5. The method of claim 1 further comprising creating at least one subsidiary microsite associated with the at least one microsite.

6. The method of claim 1 further comprising reviewing the at least one microsite activity.

7. The method of claim 1 further comprising validating the at least one recruit's personal information.

8. The method of claim 1 further comprising a platform executing at least such microsite creation, profile creation, anonymous tag creation, filtering, accessing, communication and disclosing.

9. A system for recruiting individuals using an online search community, the system comprising:
a memory for storing instructions and data, the data comprising a set of programs and a dataset having one or more data fields;
a processor executing the instructions and processing the data, wherein the instructions comprise:
creating at least one microsite associated with a firm using provided online tools;
creating at least one profile for a position associated with the at least one microsite;
creating an anonymous ID for at least one recruit;
blocking access to at least one microsite based on information provided by the at least one of the firm and at least one recruit;
enabling the at least one recruit to access the at least one profile position;
enabling the at least one recruit to communicate with at least one microsite;
enabling the at least one recruit to disclose selected identifying information; and
enabling the firm to review the at least one recruit's disclosed identifying information.

10. The system of claim 9 further comprising profiling the at least one recruit, masking the at least one recruit's identity.

11. The system of claim 9 further comprising enabling the at least one recruit to access the at least one profile position without the firm identifying the at least one recruit.

12. The system of claim 9 further comprising enabling the firm to identify and hire the at least one recruit.

13. The system of claim 9 further comprising creating at least one subsidiary microsite associated with the at least one microsite.

14. The system of claim 9 further comprising reviewing the at least one microsite activity.

15. The system of claim 9 further comprising validating the at least one recruit's personal information.

16. The system of claim 9 further comprising the processor executing at least such microsite creation, profile creation, anonymous tag creation, filtering, accessing, communication and disclosing.

17. The system of claim 9 further including a plurality of user interface devices in communication with at least the processor.

18. A non-transitory computer readable storage system including system including a set of computer instructions for aiding recruiting of individuals using an online search community, the set of instructions comprising:
a routine for creating at least one microsite associated with a firm using provided online tools;
a routine for creating at least one profile for a position associated with the at least one microsite;
a routine for creating an anonymous ID for at least one recruit;
a routine for blocking access to at least one micro site based on information provided by at least one of the firm and the at least one recruit;
a routine enabling the at least one recruit to access the at least one profile position;
a routine enabling the at least one recruit to communicate with at least one microsite;
routine enabling the at least one recruit to disclose selected identifying information; and
routine enabling the firm to review the at least one recruit's disclosed identifying information.

19. The computer readable storage system of claim 18 further comprising profiling the at least one recruit, masking the at least one recruit's identity.

20. The computer readable storage system of claim 18 further comprising enabling the at least one recruit to access the at least one profile position without the firm identifying the at least one recruit.
